(19) United States
(12) Patent Application Publication
(10) Pub. No.: US 2015/0324875 A1
(43) Pub. Date: Nov. 12, 2015

(54) PROCESS OF SPONSORSHIP OF A PURCHASE

(71) Applicant: KENNETH C. MILLER, Aptos, CA (US)

(72) Inventor: KENNETH C. MILLER, Aptos, CA (US)

(21) Appl. No.: 14/707,346

(22) Filed: May 8, 2015

Related U.S. Application Data
(60) Provisional application No. 62/128,600, filed on Mar. 5, 2015.
(60) Provisional application No. 62/102,446, filed on Jan. 12, 2015.
(60) Provisional application No. 62/048,250, filed on Sep. 9, 2014.
(60) Provisional application No. 61/990,511, filed on May 8, 2014.

(51) Int. Cl. G06Q 30/04; G06Q 20/10; G06Q 30/06; G06Q 30/02

(52) U.S. Cl. CPC G06Q 30/04; G06Q 30/0267; G06Q 20/102; G06Q 30/0601

(57) ABSTRACT

A process for sponsors such as corporations, institutions, non-profits, or individuals, to pay for customer's purchases at the time or after the time of payment, before or after a customer presents a credit card or other payment method that identifies the customer, or pays with a smartphone, tablet, smartwatch or wearable device app such as Apple Pay, or Google Wallet. Both physical and virtual, Internet, and application (app) based stores are able to practice the present invention.

### CROSS REFERENCE TO RELATED APPLICATIONS

This application claims priority benefit of U.S. Provisional Application Ser. No. 62/128,600 filed 5 Mar. 2015; and priority benefit of U.S. Provisional Application Ser. No. 62/102,446 filed 12 Jan. 2015; and priority benefit of U.S. Provisional Application Ser. No. 62/048,250 filed 9 Sep. 2014; and priority benefit of U.S. Provisional Application Ser. No. 61/990,511 filed 8 May 2014; the contents of which are hereby incorporated by reference.

### FIELD OF THE INVENTION

The present invention in general relates to the field of sponsor promotion and in particular to a sponsor giving away free items at a retail outlet and get recognition for the gifting.

### BACKGROUND OF THE INVENTION

Currently, there is no system for a third party to sponsor item giveaways at a retail outlet to assure the desired receipt of goodwill from the recipient. This is especially true in the context of meal giveaway promotions.

Thus, there exists a need an improved process for crediting a sponsor with such a giveaway.

### SUMMARY OF THE INVENTION

A process of sponsorship of a purchase includes: purchase by a retail customer via a smartphone, tablet, smartwatch or wearable device app; running an algorithm on a computer that selects the purchase, customer and/or a sponsor for potential sponsorship of the customer's purchase; signal on the selected customer smartphone, tablet, smartwatch or wearable device app that a sponsor has, or may have, made an offer to pay for the purchase; indicating the offer on the customer smartphone, tablet, smartwatch or wearable device app; querying the customer to accept the offer of the sponsor; billing the sponsor when the offer is accepted; and communicating to the sponsor the billing of the offer.

A process of sponsorship of a purchase from a merchant includes: requesting the purchase from the merchant by a retail customer; running an algorithm on a computer that signals the merchant that a sponsor has made an offer to pay for the purchase requested by the retail customer; querying the retail customer to accept the offer of the sponsor; billing the sponsor when the offer is accepted; and communicating to the sponsor the billing of the offer.

A process of sponsorship of a purchase from a merchant includes: purchase from the merchant by a retail customer; running an algorithm on a computer that signals the merchant and/or customer that a sponsor has, or may have, made an offer to pay for the purchase; indicating the offer on a merchant receipt; querying the retail customer to accept the offer of the sponsor; billing the sponsor when the offer is accepted; and communicating to the sponsor the billing of the offer.

### DESCRIPTION OF THE INVENTION

The present invention has utility as a process for sponsors (corporations, institutions, non-profits, individuals, etc.) to pay for customer's purchases at the time or after the time of payment (before or after a customer presents a credit card or other payment method that identifies the customer, or pays with a smartphone, tablet, smartwatch or wearable device app such as Apple Pay, Google Wallet, etc.). While the present invention is further detailed with respect to a meal giveaway in a restaurant setting, it is appreciated that this is readily extended to other retail items in other retail settings such as supermarkets, electronics stores, hardware stores, drug stores, convenience stores, and clothing stores. It is also appreciated that both physical (brick and mortar) and virtual, Internet, and application (app) based stores are able to practice the present invention.

According to the present invention, the customer goes to the merchant and selects their items for purchase. A bill is presented to the customer and the customer pays the merchant with cash, check, credit card, or other payment method. The merchant prints a receipt that contains an indication to the merchant service provider illustratively including a cashier, a waiter, etc. that informs the service provider that the bill is available to be paid by a sponsor and the identity of the sponsor. The receipt also contains an access code and/or barcode that the customer can use to obtain a refund or credit for the bill. In a specific embodiment, the indication that informs the service provider that the bill is available to be paid by the sponsor and identity of the sponsor is sent to the merchant service provider via a register or a tablet device. The service provider then informs the customer that their purchase may be paid for by that sponsor (i.e., “would you like to have your meal paid for by company X”?). It is appreciated that in some embodiments, the sponsor offers to pay for a particular item the customer has purchased, a portion of the item or bill, or in other embodiments, the sponsor offers to pay the entire bill of the purchase. If the customer is interested in the offer, the customer verbally accepts the offer or logs onto a website or accesses an app and enters the access code or scans the barcode. The customer is then presented with a list of questions which if answered, the bill, or a portion of the bill is paid by the sponsor and the amount is debited from the sponsor account. The sponsor ledger is then provided to the sponsor in various forms illustratively including electronically, in paper form, via wireless network, or combinations thereof. It is appreciated that in some embodiments, the sponsor is supplied information about the purchaser whose bill has been paid as collected by the merchant at the time of purchase. If the offer is declined, the offer is retracted and can be used for a different customer under circumstances illustratively including in a different retail establishment, different location of the same chain of stores, different time, different algorithmic based bill, or a combination thereof

An algorithm based on user selected criteria is invoked to designate the entire purchase, selected item or customer to receive an offer of sponsor payment. The algorithm operative herein illustratively includes random number generator, customer demographics, customer purchase history, time of day, total purchase value, or combinations thereof. The algorithm operates on a computer and in some embodiments is in electronic communication with the retail establishment register computers, while in other embodiments the algorithm is run on the cash register computer. It is appreciated that wireless devices are readily provided in communication with the algorithm signal communication to allow a waiter for example to complete the transaction and sponsorship offer remote from the register itself at a location such as a patron table.

In a specific inventive embodiment when a bill for a purchase or service is presented to the customer and the customer pays the merchant with a smartphone payment app. The smartphone App may have an algorithm based on user selected criteria and is invoked to select the customer who is to receive an offer of sponsor payment. The application based algorithm operative herein illustratively includes a random number generator, customer demographics, customer purchase history, time of day, total purchase value, or combinations thereof The algorithm operates on a computer and in some embodiments is in electronic communication with the retail establishment register computers, the payment app, or third party app, while in other embodiments the algorithm is run on the cash register computer.

The merchant's electronic payment system sends a message to the customer's payment app (or other/third party app on the customer's smartphone, tablet, smartwatch, or wearable device) that informs the customer that the bill is available to be paid by a sponsor and the identity of the sponsor. The message also contains a button to push, access code, and/or barcode that the customer can use to obtain a refund or credit for the bill. The message informs the customer that their purchase may be paid for by that sponsor. It is appreciated that in some embodiments, the sponsor offers to pay for a particular item the customer has purchased, a portion of the item or bill, or in other embodiments, the sponsor offers to pay the entire bill of the purchase. In a specific embodiment multiple offers from different sponsors may be made and be accepted for the same purchase, the total of which cannot exceed the total purchase value.

In an alternative embodiment, a machine readable code such as a bar code or QR code is exchanged between the merchant financial transactional and a customer smartphone, tablet, smartwatch or wearable device. In a particular embodiment, the machine readable code is displayed on a merchant device and scanned by the customer device to accept the offer and direct the customer to various survey questions or promotional materials. In other embodiments, the machine readable code is generated on the consumer device via website access, text message, or other digital communication; the machine readable code is then scanned by a merchant device to pay for all or part of the amount owed by the customer.

Upon a customer accessing the third party potential payor website or smartphone, tablet, smartwatch or wearable device app, the customer is then presented with a list of questions (i.e.: “would you like to have your meal paid for by company X”?) which, if answered yes, the bill, or a portion of the bill is paid by the sponsor and the amount is debited from the sponsor account and applied to the customer's account. The sponsor ledger is then provided to the sponsor in various forms illustratively including electronically, in paper form, via wireless network, or combinations thereof. It is appreciated that in some embodiments, the sponsor is supplied information about the purchaser whose bill has been paid as collected by the app at the time of sponsorship. If the offer is declined, the offer is retracted and can be used for a different customer under circumstances illustratively including in a different retail establishment, different location of the same chain of stores, different time, different algorithmic based bill, or a combination thereof

In certain inventive embodiments, upon declination of the sponsorship, the customer is asked to give a reason why they declined the offer. Such reasons illustratively include having enough money, not liking the sponsor, want to help someone else, etc.

An algorithm based on user selected criteria is invoked to designate the entire purchase, portion, or selected item for customer to receive an offer of sponsor payment. The algorithm operative herein illustratively includes random number generator, customer demographics, customer purchase history, time of day, total purchase value, or combinations thereof. The algorithm operates on a computer and in some embodiments is in electronic communication with the retail establishment register computers, the payment app, or third party app, while in other embodiments the algorithm is run on the cash register computer.

In specific inventive embodiments, a printer may be provided at a point of purchase of the retail location for sponsors (corporations, institutions, non-profits, individuals, etc.) to print their advertising on the retailer's bags, boxes and/or containers at the time and location of the sale sponsorship; or labels/stickers are printed to be attached to the retailer's bags, boxes, containers and/or directly on products themselves; or pre-printed labels/stickers are provided with the sponsor's advertising for the attachment at the time of sponsorship.

The products purchased and partially or fully paid for by a sponsor are put in the newly printed bag, box and/or container and given to the customer; or the newly printed label/sticker is affixed to the bag, box, container, and/or product and given to the customer; or the pre-printed label/sticker is affixed to the bag, box, container, and/or product and given to the customer.

The foregoing description is illustrative of particular embodiments of the invention, but is not meant to be a limitation upon the practice thereof. The following claims, including all equivalents thereof, are intended to define the scope of the invention.

1. A process of sponsorship of a purchase comprising:
purchase by a retail customer via a smartphone, tablet, smartwatch or wearable device app;
running an algorithm on a computer that selects the purchase, customer and/or a sponsor for potential sponsorship of the customer's purchase;
signal on the selected customer smartphone, tablet, smartwatch or wearable device app that a sponsor has, or may have, made an offer to pay for the purchase;
indicating the offer on the customer smartphone, tablet, smartwatch or wearable device app;
querying the customer to accept the offer of the sponsor;
billing the sponsor when the offer is accepted; and
communicating to the sponsor the billing of the offer.

2. The process of claim 1 wherein the offer is for a single item of the purchase.

3. The process of claim 1 wherein the offer is for a percentage of the purchase.

4. The process of claim 3 wherein multiple offers from a set of different sponsors can be accepted for the same purchase, the total of which cannot exceed the total purchase value.

5. The process of claim 1 wherein the offer is for all items of the purchase.

6. The process of claim 1 wherein the algorithm selects the purchase, customer and/or sponsor based on a random number generator, demographics of the customer, purchase history of the customer, a time of day, total purchase value, or combinations thereof.

7. The process of claim 1 wherein the merchant is a restaurant.

8. The process of claim 1 wherein the merchant is an Internet retailer.

9. The process of claim 1 further comprising communicating information provided to the merchant by the customer as part of the offer to the sponsor.

10. The process of claim 1 wherein a time limit for offer after payment is provided.

11. The process of claim 10 further comprising the offer diminishing or disappearing with lapse of the time limit.

12. The process of claim 1 further comprising downloading an app onto the smartphone, the smartwatch, or the tablet as a basis for receiving the signal.

13. The process of claim 1 where the signal is communicated by way of a machine readable code exchanged between the smartphone, the smartwatch, or the tablet and a merchant device.

14. A process of sponsorship of a purchase from a merchant comprising:
requesting the purchase from the merchant by a retail customer;
running an algorithm on a computer that signals the merchant that a sponsor has made an offer to pay for the purchase requested by the retail customer;
querying the retail customer to accept the offer of the sponsor;
billing the sponsor when the offer is accepted; and
communicating to the sponsor the billing of the offer.

15. The process of claim 14 wherein the offer is for a single item of the purchase or the order is for all items of the purchase.

16. The process of claim 14 wherein the algorithm selects the purchase based on a random number generator, demographics of the customer, purchase history of the customer, a time of day, total purchase value, or combinations thereof.

17. The process of claim 14 further comprising communicating information provided to the merchant by the customer as part of the offer to the sponsor.

18. A process of sponsorship of a purchase from a merchant comprising:
purchase from the merchant by a retail customer;
running an algorithm on a computer that signals the merchant and/or customer that a sponsor has, or may have, made an offer to pay for the purchase;
indicating the offer on a merchant receipt
querying the retail customer to accept the offer of the sponsor;
billing the sponsor when the offer is accepted; and
communicating to the sponsor the billing of the offer.

19. The process of claim 18 wherein the receipt further comprises an access code and/or barcode that the retail customer can use to obtain a refund or credit for the bill.

20. The process of claim 19 wherein the customer logs onto a website or accesses an app and enters the access code or scans the barcode; and
wherein the customer is then presented with a list of questions which if answered, the bill, or a portion of the bill is paid by the sponsor and the amount is debited from the sponsor account.
